(19) United States
(12) Patent Application Publication
(10) Pub. No.: US 2024/0195110 A1
(43) Pub. Date: Jun. 13, 2024

(54) CONNECTOR FITTING STRUCTURE

(71) Applicant: YAZAKI CORPORATION, Tokyo (JP)

(72) Inventors: Takenori Ohmura, Kakegawa-shi (JP); Yoshitaka Tsushima, Kakegawa-shi (JP); Masaya Okamoto, Kakegawa-shi (JP); Yukinari Naganishi, Susono-shi (JP); Koji Ikegaya, Susono-shi (JP)

(21) Appl. No.: 18/536,228

(22) Filed: Dec. 12, 2023

(30) Foreign Application Priority Data
Dec. 12, 2022 (JP) 2022-197911

(51) Int. Cl. H01R 13/502; H01R 13/52; H01R 13/631

(52) U.S. Cl. CPC H01R 13/502; H01R 13/5213; H01R 13/631

(57) ABSTRACT

A connector fitting structure, between a first connector and a second connector that are fitted and electrically connected to each other, is provided. The first connector includes a first housing that accommodates a first connection terminal. The second connector includes a second housing that accommodates a second connection terminal, and an abutment portion that is provided on a portion of the second housing and against which the first housing abuts before the first connector is fitted into the second connector. The abutment portion includes a concave portion and a convex portion, A front end of the convex portion is configured to be an abutment surface.

### CROSS-REFERENCE TO RELATED APPLICATION(S)

This application is based upon and claims the benefit of priority from prior Japanese patent application No. 2022-197911 filed on Dec. 12, 2022, the entire contents of which are incorporated herein by reference.

### BACKGROUND

### 1. Field of the Invention

The present disclosure relates to a connector fitting structure.

### 2. Description of the Related Art

In the related art, wire harnesses (electric wires) that electrically connect various electrical components mounted in automobiles and the like are connected by connectors. For example, in an electric vehicle and the like equipped with a battery, the battery is charged by fitting a power supply connector (plug), which is a mating connector, into a charging connector (inlet) installed in a vehicle body. An example of such a connector includes a connector described in JP2022-133223A.

The connector (inlet) described in JP2022-133223A includes an outer case that accommodates and holds a housing accommodating connection terminals, and a movable case that has a cam groove formed therethrough and is disposed to be movable in a connector fitting direction in the outer case. In addition, the connector includes a shutter, and a spring that elastically biases the movable case toward an inlet plug. The shutter includes a shutter front wall that covers a front opening of the housing, and a shutter boss that engages with the cam groove. When the cam groove is engaged with the shutter boss, the shutter is rotated in an opening and closing direction around the shutter boss in conjunction with the movement of the movable case. According to this connector, since the shutter is rotated in the opening and closing direction via the movable case, it is not necessary to lengthen a fitting hood part of the mating connector in consideration of the opening and closing locus of the shutter. In the fitting operation between the connector (inlet) and the mating connector, first, the mating connector is abutted against a top plate forming the outer case of the connector, and then moved toward the connector, such that the mating connector starts to be inserted and fitted into the connector.

However, in the connector described in JP2022-133223A, since the top plate, against which the mating connector abuts during the fitting operation, is always exposed and has a planar shape, it is susceptible to the adhesion or accumulation of foreign matter such as mud and water. When a large amount of foreign matter adheres to this top plate, there is a concern that the connector and the mating connector may not be properly fitted together.

### SUMMARY

The present disclosure has been made in view of the circumstances described above, and an object of the present disclosure is to provide a connector fitting structure capable of suppressing the occurrence of poor fitting.

According to a aspect of the present disclosure, there is provided a connector fitting structure between a first connector and a second connector that are fitted and electrically connected to each other, in which: the first connector includes a first housing that accommodates a first connection terminal; the second connector includes a second housing that accommodates a second connection terminal, and an abutment portion that is provided on a portion of the second housing and against which the first housing abuts before the first connector is fitted into the second connector; the abutment portion includes a concave portion and a convex portion; and a front end of the convex portion is configured to be an abutment surface.

The connector fitting structure according to the present disclosure has the effect of suppressing the occurrence of poor fitting.

The present disclosure has been briefly described above. Furthermore, the details of the present disclosure will be further clarified by reading the modes for carrying out the disclosure described below (hereinafter referred to as “embodiments”) with reference to the attached drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view showing an inlet as an example of a second connector that is a component of a connector fitting structure according to an embodiment of the present disclosure, and an inlet plug as an example of a first connector fitted into the inlet;

FIG. 2 is an exploded perspective view of the inlet shown in FIG. 1;

FIG. 3 is a perspective view schematically showing an abutment portion shown in FIG. 2;

FIG. 4 is a view showing a section A-A in FIG. 3 in detail;

FIG. 5 is a cross-sectional view showing a state before the inlet and inlet plug shown in FIG. 1 are fitted together;

FIG. 6 is a cross-sectional view showing a state in which the inlet and inlet plug shown in FIG. 1 are being fitted together; and

FIG. 7 is a cross-sectional view showing a state in which the inlet and inlet plug shown in FIG. 1 are completely fitted.

### DETAILED DESCRIPTION OF THE INVENTION

Specific embodiments relating to the present disclosure will be described below with reference to the drawings.

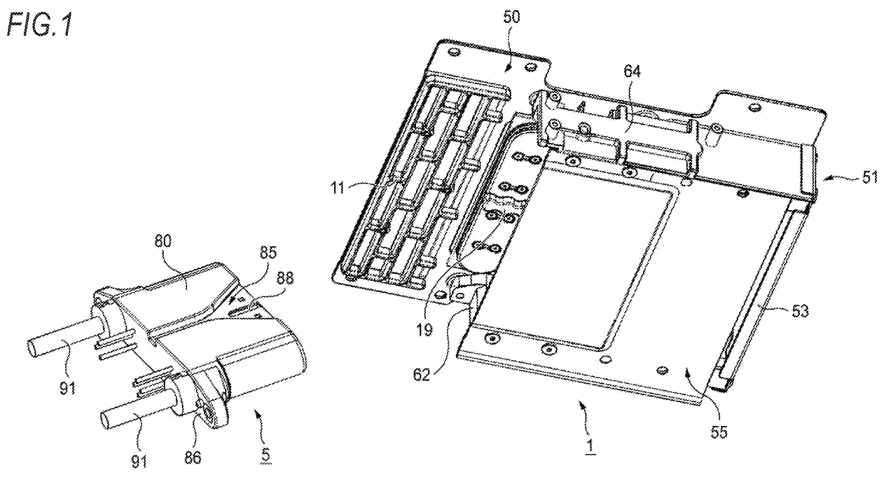

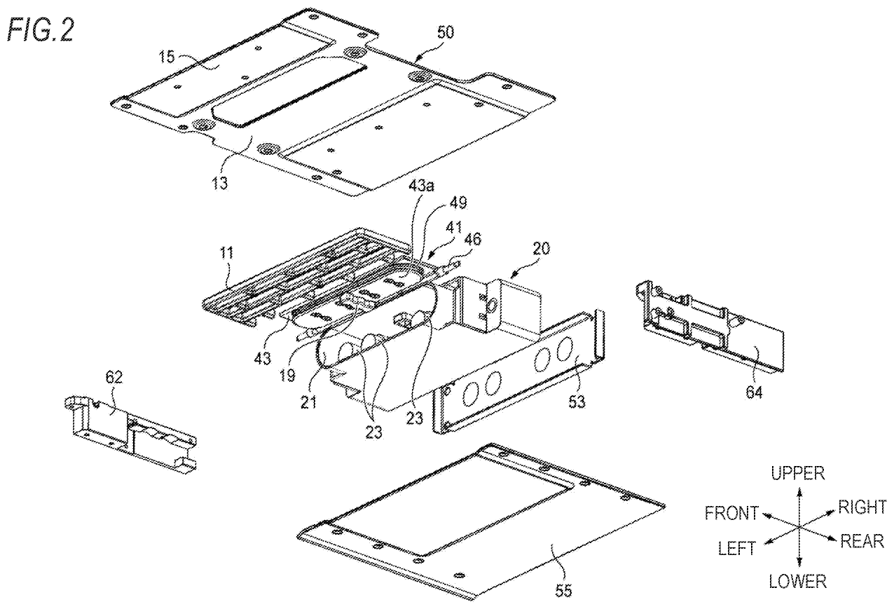

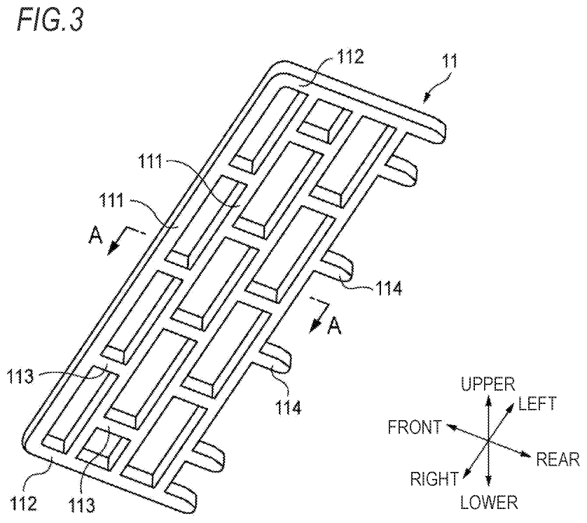

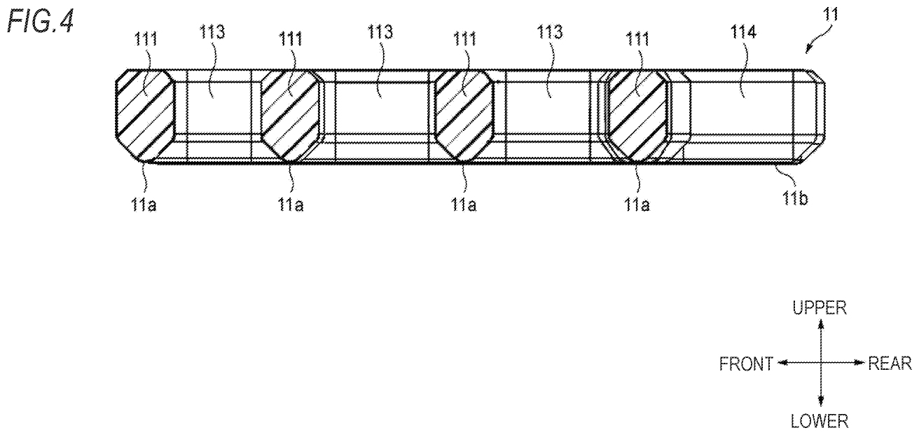

FIG. 1 is a perspective view showing an inlet as an example of a second connector 1 that is a component of a connector fitting structure according to the embodiment of the present disclosure, and an inlet plug 5 as an example of a first connector fitted into the inlet. FIG. 2 is an exploded perspective view of the inlet 1 shown in FIG. 1. FIG. 3 is a perspective view schematically showing an abutment portion shown in FIG. 2. FIG. 4 is a view showing a section A-A in FIG. 3 in detail. Hereinafter, for convenience of explanation, a “front-rear direction”, a “left-right direction”, and an “up-down direction” are defined as shown in FIG. 2. The “front-rear direction”, the “left-right direction”, and the “up-down direction” are orthogonal to one another. For example, the inlet 1 is attached to a body of an electric vehicle and the like, but the direction shown in the drawings and the direction of the attachment to the body and the like do not necessarily match with each other.

As shown in FIGS. 1 and 2, the inlet 1 includes a housing 20 that accommodates a connection terminal (second connection terminal), and an outer case 51 that accommodates and holds the housing 20. A portion of the outer case 51 is provided with an abutment portion 11 against which a plug housing 80 of the inlet 1 abuts before the inlet plug 5 is fitted into the inlet 1. The abutment portion 11 includes a concave portion and a convex portion, and a front end of the convex portion serves as an abutment surface. Details of the abutment portion 11 will be described below. The outer case 51 is an example of a second housing.

The housing 20 of the inlet 1 is molded from electrically insulating synthetic resin. The housing 20 includes a pair of terminal accommodating cylindrical portions 23 and 23 that protrude toward the inlet plug 5, a hollow cylindrical hood part 21 that covers the pair of terminal accommodating cylindrical portions 23 and 23, and a rear wall that is provided with the pair of terminal accommodating cylindrical portions 23 and 23, and closes the rear of the hood part 21.

A connection terminal connected to an end portion of a high voltage cable is accommodated in the terminal accommodating cylindrical portion 23. The high voltage cable connected to the connection terminal is pulled out from a rear end opening of the terminal accommodating cylindrical portion 23. It is to be noted that in FIGS. 1 and 2, illustration of the high voltage cable is omitted.

A front opening 25, into which the connection terminal (first connection terminal) of the inlet plug 5 is inserted, is formed at a fore end of the terminal accommodating cylindrical portion 23. The front opening 25 is an example of an opening into an accommodation space for the connection terminal of the housing 20.

The outer case 51 is a flat housing that includes a bottom plate 55, side wall members 62 and 64, a top plate 50, and a rear plate 53.

The bottom plate 55 is a flat plate smaller in size than the top plate 50.

The side wall members 62 and 64 are arranged on both left and right sides of the housing 20 and form both side walls of the outer case 51. The side wall members 62 and 64 each have a substantially U-shaped concave portion on an upper surface. Both ends of a rotation shaft 46 of a connector cover 41 to be described below are supported between the concave portions and the top plate 50, respectively. An actuator (not shown) for rotationally driving the rotation shaft 46 is fixed to a right side surface of a side wall member 64 with screws.

The top plate 50 includes an eaves portion 15 extending in front of an upper wall portion 13 that defines a housing accommodation space together with the bottom plate 55 and the side wall members 62 and 64.

A lower surface of the eaves portion 15 is provided with the abutment portion 11 against which the plug housing 80 of the inlet 1 abuts before the inlet plug 5 is fitted into the inlet 1. The abutment portion 11 is fixed to the eaves portion 15 with screws. As shown in FIG. 3, the abutment portion 11 is formed in a lattice shape including a plurality of rod-shaped members 111 extending along the left-right direction and a plurality of rod-shaped members 112, 113, and 114 extending along the front-rear direction. The rod-shaped members 111, 112, 113, and 114 are formed to be as thin as possible within a range that does not compromise the strength. The abutment portion 11 includes convex portions which are the positions on the lower surface of the eaves portion 15 where the rod-shaped members 111, 112, 113, and 114 are arranged, and concave portions which are the positions where the rod-shaped members 111, 112, 113, and 114 are not arranged, that is, the positions where the lower surface of the eaves portion 15 is exposed.

If the abutment portion 11 is not provided on the eaves portion 15, in an environment in which the inlet plug 5 is not fitted into the inlet 1, the eaves portion 15 is constantly exposed to the outside, and foreign matter such as mud and water is likely to adhere, the eaves portion 15 with a flat plate shape is susceptible to the adhesion and accumulation of the foreign matter. When a large amount of foreign matter adheres to the eaves portion 15, poor fitting is likely to occur.

On the other hand, in the inlet 1 of the present embodiment, the eaves portion 15 is provided with the abutment portion 11, and front ends 11a (lower ends) of the rod-shaped members 111, 112, 113, and 114 (convex portions) forming the abutment portion 11 serve as an abutment surface 11b (see FIG. 4). Therefore, an area of the abutment surface can be reduced by at least an area corresponding to the concave portions. Therefore, foreign matter adhering to and accumulating on the abutment surface can be reduced. As a result, the plug housing 80 is abutted against the abutment surface 11b formed by the front end, and then the inlet plug 5 is fitted into the inlet 1, so that the susceptibility to the adhesion and accumulation of foreign matter is reduced, and it is possible to suppress the occurrence of poor fitting.

The plurality of rod-shaped members 111 are arranged at regular intervals in the front-rear direction, and the rod-shaped members 112 are respectively arranged on both left and right ends to connect the plurality of rod-shaped members 111 to each other. The plurality of rod-shaped members 113 shorter than the rod-shaped members 112 are arranged between adjacent rod-shaped members 111 to connect the rod-shaped members 111 to each other. The plurality of rod-shaped members 113 are arranged at regular intervals in the left-right direction. The plurality of rod-shaped members 114 are arranged so as to extend rearward on the rear side of the rod-shaped member 111 arranged at the rearmost position. The plurality of rod-shaped members 114 are arranged at regular intervals in the left-right direction.

Each of the rod-shaped members 111, 112, 113, and 114 has a substantially octagonal prism shape. More specifically, as shown in FIG. 4, in the cross sections along the up-down direction and the front-rear direction, the rod-shaped member 111 has a width (size in the front-rear direction) of a lower front end 11a that is narrower than a distance (hereinafter referred to as a size of a middle part) between two mutually parallel sides extending in the up-down direction. A width of a base end of the rod-shaped member 111 on the eaves portion 15 side, that is, on the upper side, is also slightly smaller than the size of the middle part, but a cross-sectional area of the front end 11a is formed to be smaller than a cross-sectional area of the base end. Similarly to the rod-shaped member 111, the other rod-shaped members 112, 113, and 114 are also formed such that the front end 11a (lower end) is thinned. Since the front end 11a is formed to be thinned, water adhering to the abutment portion 11 easily falls off, so that accumulation of water can be suppressed. Therefore, promotion of dust adsorption can be suppressed and damage caused by freezing can be suppressed.

The rod-shaped member 114 is not connected to any member at a rear end. In other words, one end of the rod-shaped member 114 near the connection terminal accommodated in the terminal accommodating cylindrical portion 23 is open. If the rear end of the rod-shaped member 114 is not open and is connected to another member and the like, when foreign matter adheres to the rod-shaped member 114, the foreign matter is blocked and accumulated when the inlet plug 5 and the inlet 1 are fitted together, which may cause poor fitting. On the other hand, in the inlet 1, since the rear end of the rod-shaped member 114 is open, foreign matter is not accumulated, so that poor fitting can be further suppressed.

In the abutment portion 11 configured as described above, the rod-shaped members 111, 112, 113, and 114 are formed to be as thin as possible within a range that does not compromise the strength.

The rear plate 53 is a substantially rectangular flat plate with four sides bent. The rear plate 53 includes the bottom plate 55, the side wall members 62 and 64, and the top plate 50, and covers and closes the accommodation space accommodating the housing 20 from the rear.

The inlet 1 further includes the connector cover 41 and a pick-up rib 19 provided on the connector cover 41. The connector cover 41 is provided so as to be rotatable between a closed position to cover an opening to the accommodation space of the connection terminal of the outer case 51, that is, the front opening of the hood part 21, and an open position not to cover the opening. The pick-up rib 19 is an example of a guide protrusion.

The connector cover 41 includes a substantially rectangular plate-shaped cover part 43 that covers the front opening of the hood part 21 and the rotation shaft 46 provided at an end of the cover part 43 on the long side side.

As shown in FIG. 2, the cover part 43 is provided with a cylindrical rib 43a corresponding in shape to an opening edge of the hood part 21 on a surface facing the terminal accommodating cylindrical portion 23, and there is an elastic packing 49 attached to an outer circumferential surface of the cylindrical rib 43a. The elastic packing 49 is molded from an elastic member such as sponge or rubber. The elastic packing 49 can come into elastic contact with the hood part 21 of the housing 20 when the connector cover 41 is closed, that is, when the connector cover 41 is in the closed position. Therefore, it is possible to more reliably prevent ingress of dust, water, and the like into the hood part 21 of the housing 20.

The rotation shaft 46 is made of metal, for example, and is molded integrally with the cover part 43 made of synthetic resin.

The pick-up rib 19 is inserted into a fitting guide groove 85 that is an example of a guide groove. The fitting guide groove 85 is provided in the plug housing 80 of the inlet plug 5. The pick-up rib 19 guides the plug housing 80 of the inlet plug 5 to be fitted into the housing 20 accommodated in the outer case 51. The pick-up rib 19 is provided at a center of a surface of the cylindrical rib 43a facing the terminal accommodating cylindrical portion 23. The pick-up rib 19 extends in a connector fitting direction when the connector cover 41 is in an open state. The pick-up rib 19 is accommodated in the housing 20 when the connector cover 41 is in a closed state.

The pick-up rib 19 has a rounded tip, has a substantially rectangular parallelepiped shape in which a length in the connector fitting direction is longer than a length in the left-right direction, and has a plurality of concave portions formed at predetermined intervals on both left and right side surfaces facing groove side surfaces of the fitting guide groove 85. The predetermined interval is appropriately determined in consideration of the size of the pick-up rib 19, the size of the fitting guide groove 85, and the like.

The inlet 1 is assembled as follows. The abutment portion 11 is fixed to the lower surface of the eaves portion 15 of the top plate 50 with screws. The side wall members 62 and 64 are respectively arranged on the left and right sides of an upper surface of the bottom plate 55 and fixed thereto with screws. The housing 20 accommodating the connection terminals is disposed between the side wall members 62 and 64 on the bottom plate 55, and the connector cover 41 is disposed such that both ends of the rotation shaft 46 are accommodated in the respective concave portions of the side wall members 62 and 64. In addition, the top plate 50 is placed on upper surfaces of the side wall members 62 and 64 so as to cover an upper part of the housing 20, and is fixed to the side wall members 62 and 64 with screws. The top plate 50 is further fixed to an upper surface of the housing 20 with screws. In this way, the rear plate 53 is attached, from the rear, to the bottom plate 55, the side wall members 62 and 64, and the top plate 50 that cover the lower, side, and upper parts of the housing 20, and is fixed to the side wall members 62 and 64 with screws. The assembled inlet 1 is attached to the body of an electric vehicle and the like, for example, via the top plate 50.

The inlet plug 5 shown in FIG. 1 includes a plug-side connection terminal that is fitted into the connection terminal of the inlet 1, and the plug housing 80 that is an example of a first housing that accommodates the plug-side connection terminal.

The plug housing 80 is molded from electrically insulating synthetic resin. A bracket 86 is attached to the plug housing 80.

The fitting guide groove 85 is formed on an upper surface of the plug housing 80. The fitting guide groove 85 has a tapered portion whose width increases toward the inlet 1. When the inlet plug 5 is fitted into the inlet 1, the fitting guide groove 85 can guide the plug housing 80 to be fitted into the housing 20 by engaging with the pick-up rib 19.

A terminal accommodating chamber 83 in the plug housing 80 accommodates a connection terminal connected to an end portion of a plug-side high voltage cable 91. The plug-side high voltage cable connected to the connection terminal is pulled out from a rear end opening of the terminal accommodating chamber.

Since a portion of the top plate 50 (the eaves portion 15) is exposed when the inlet 1 and the inlet plug 5 are not fitted together, there is a concern that foreign matter such as mud or water may adhere or accumulate. On the other hand, in the inlet 1 of the present embodiment, the abutment portion 11 is provided on a portion of the top plate 50, and the front ends 11a of the rod-shaped members 111, 112, 113, and 114 serve as the abutment surfaces 11b, so that an area to which foreign matter may adhere can be reduced, and the influence of foreign matter on a fitting operation can be alleviated.

Further, when the inlet 1 and the inlet plug 5 are not fitted together, the connector cover 41 is in a closed position where the cover part 43 covers the front opening of the housing 20. Therefore, the inlet 1 is dustproof, terminal protected, and prevented from electric shock. Further, when the connector cover 41 is in the closed position, the pick-up rib 19 provided on the cylindrical rib 43a of the cover part 43 is accommodated in the housing 20. Therefore, the pick-up ribs 19 of the inlet 1 are protected from scratch damage and adhesion of foreign matter.

Therefore, problems in fitting between the inlet 1 and the inlet plug 5 are prevented. Furthermore, since foreign matter is prevented from adhering to the pick-up rib 19, foreign matter adhering to the pick-up rib 19 is prevented from entering the inlet plug 5. Since the connector cover 41 is in the closed position and the pick-up rib 19 is accommodated in the inlet 1 while the vehicle is traveling, the scratch damage and adhesion of foreign matter to the pick-up rib 19 can be prevented, and the inlet 1 and the inlet plug 5 can be reliably fitted together.

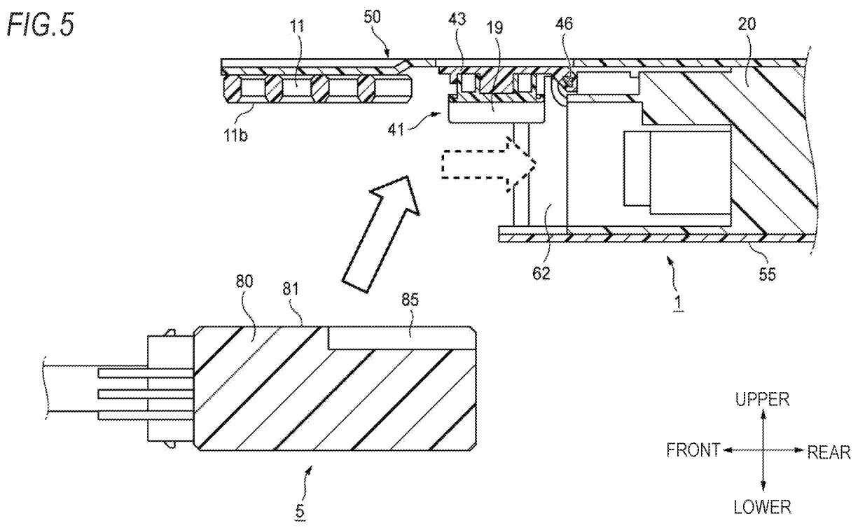

Next, the fitting operation between the inlet 1 and the inlet plug 5 described above will be described with reference to FIGS. 5 to 7. FIGS. 5 to 7 show cut surfaces along the fitting direction at a center of the inlet 1 in the left-right direction.

When starting insertion and fitting of the inlet plug 5 into the inlet 1, the actuator rotates the rotation shaft 46 of the inlet 1, thereby rotating the cover part 43 of the connector cover 41 to the open position. The connector cover 41 is rotated to the open position, and the upper surface of the cover part 43 is disposed along the lower surface of the top plate 50, as shown in FIG. 5. The connector cover 41 is preferably opened immediately before the inlet plug 5 is inserted and fitted into the inlet 1 from a viewpoint of pick-up rib 19 protection, dust prevention, terminal protection, and electric shock prevention.

With respect to the inlet 1 with the connector cover 41 in the open state, the inlet plug 5 is moved in the direction of the arrow indicated by a solid line in FIG. 5 to abut an upper surface 81 of the plug housing 80 against the abutment surface 11b of the abutment portion 11. Then, the inlet plug 5 is moved in the direction of the arrow shown by a broken line, and the plug housing 80 starts to be inserted and fitted into the outer case 51.

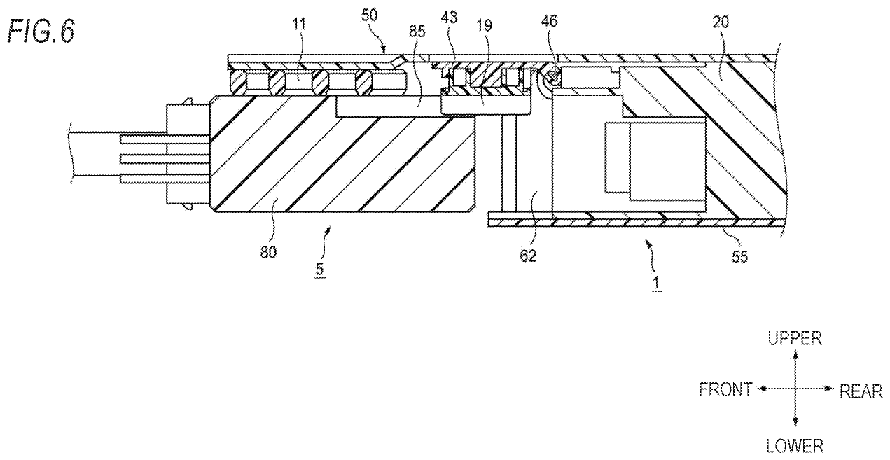

During the fitting shown in FIG. 6, the upper surface 81 of the plug housing 80 is in contact with a lower surface (the abutment surface 11b) of the abutment portion 11, and the pick-up rib 19 is inserted into the fitting guide groove 85. A lower surface of the cylindrical rib 43a, which is a surface on which the pick-up rib 19 is provided, and the lower surface (the abutment surface 11b) of the abutment portion 11 are set to be at the same height. Therefore, the plug housing 80, which is moved while the upper surface 81 of the plug housing 80 is in contact with the abutment surface 11b, is smoothly guided by the engagement between the pick-up rib 19 and the fitting guide groove 85.

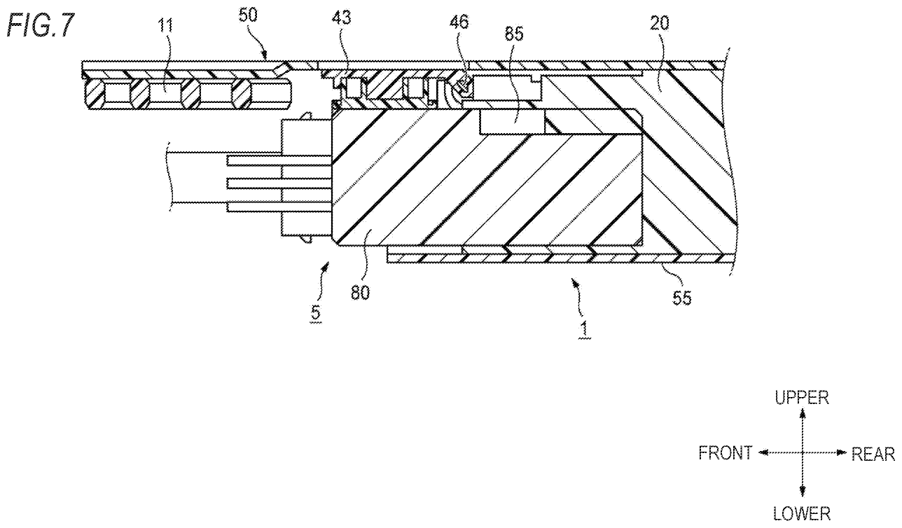

When the inlet plug 5 is further inserted deeply toward the rear of the inlet 1, the tip of the pick-up rib 19 is guided into the fitting guide groove 85, and a fore end of the plug housing 80 abuts against the rear wall of the housing 20 (see FIG. 7). In this state, the connection terminal of the inlet plug 5 is fitted and connected to the connection terminal of the inlet 1, whereby the high voltage cable on the inlet 1 side and the plug-side high voltage cable 91 are electrically connected to be used. After use, the inlet plug 5 is detached from the inlet 1. Then, when the actuator rotates the rotation shaft 46 in the opposite direction, the connector cover 41 is in the closed state. In this state, since the cover part 43 is in the closed position, the inside of the housing 20 is protected.

As described above, according to the fitting structure between the inlet 1 and the inlet plug 5, the inlet 1 has the abutment portion 11 on a portion of the top plate 50, and the front ends 11a of the rod-shaped members 111, 112, 113, and 114 serves as the abutment surface 11b. Therefore, when the inlet plug 5 is not inserted and fitted into the inlet 1, the area to which foreign matter may adhere can be reduced. Therefore, the influence of foreign matter on the fitting between the inlet 1 and the inlet plug 5 can be alleviated, and poor fitting can be suppressed.

It is to be noted that the present disclosure is not limited to the embodiments described above, but may encompass modifications or improvements, as appropriate. In addition, materials, shapes, dimensions, numbers, positions, and the like of the elements in the embodiment described above are not limited, but are freely selected as far as the present disclosure can be achieved.

For example, in the embodiment described above, the example has been shown in which the inlet 1 has the lattice-like abutment portion 11 including the rod-shaped members 111, 112, 113, and 114 fixed to the top plate 50 with screws, but the abutment portion may be integrally molded with the top plate. Moreover, the shape of the abutment portion is not limited as long as a concave portion and a convex portion are at a position where the abutment portion is disposed. For example, the abutment portion may have a projection ridge extending linearly or curved, or a conical projection ridge such as a cone or a pyramid. The abutment portion may have a projection ridge or projection of which cross-sectional shape along the protrusion direction is arcuate or polygonal.

Further, in the embodiment described above, the inlet 1 has the connector cover 41, but the connector fitting structure of the present disclosure can also be applied to a connector that does not have the connector cover. Further, in the embodiment described above, the fitting structure between the inlet and the inlet plug used in the electric vehicle and the like has been explained as an example, but the connector fitting structure of the present disclosure is not limited thereto, and can be applied to various connectors based on the spirit of the present disclosure.

Here, the features of the connector fitting structure according to the embodiment of the present disclosure described above will be briefly summarized and listed below in [1] to [6].

[1] A connector fitting structure between a first connector (the inlet plug 5) and a second connector (the inlet 1) that are fitted and electrically connected to each other, in which
the first connector (the inlet plug 5) includes a first housing (the plug housing 80) that accommodates a first connection terminal,
the second connector (the inlet 1) includes a second housing (the outer case 51) that accommodates a second connection terminal, and the abutment portion 11 that is provided on a portion (the eaves portion 15) of the second housing and against which the first housing abuts before the first connector is fitted into the second connector,
the abutment portion includes a concave portion and a convex portion, and
a front end of the convex portion is configured to be an abutment surface.

For example, if a flat plate-shaped portion is used as the abutment portion, in an environment in which the first connector is not fitted to the second connector and foreign matter such as mud or water is likely to adhere or accumulate, the flat plate-shaped abutment portion is susceptible to adhesion and accumulation of foreign matter, and when a large amount of foreign matter adheres, poor fitting is likely to occur. On the other hand, according to the connector fitting structure configured as described in [1], since the abutment portion includes the concave portion and the convex portion, and the front end of the convex portion serves as the abutment surface, the area of the abutment surface can be reduced by at least the area corresponding to the concave portion. Therefore, foreign matter adhering to and accumulating on the abutment surface can be reduced. Therefore, the first housing is abutted against the abutment surface formed by the front end of the convex portion, and then the first connector is fitted into the second connector, so that the susceptibility to the adhesion and accumulation of foreign matter is reduced, and it is possible to suppress the occurrence of poor fitting.

[2] The connector fitting structure according to [1], in which a cross-sectional area of the front end of the convex portion is smaller than a cross-sectional area of a base end on the second housing side.

According to the connector fitting structure configured as described in [2], since the front end of the convex portion is formed to be thinned, accumulation of water can be suppressed. Therefore, it is possible to suppress the promotion of dust adsorption with respect to the abutment portion and to suppress the damage caused by freezing. Therefore, poor fitting due to adhesion of foreign matter can be further suppressed.

[3] The connector fitting structure according to [1], in which the abutment portion includes the rod-shaped members 112, 113, and 114 extending along the fitting direction (front-rear direction) between the first connector and the second connector.

According to the connector fitting structure configured as described in [3], a portion of the rod-shaped member can serve as the abutment surface. Therefore, the strength of the abutment portion in the fitting direction can be maintained.

[4] The connector fitting structure according to [3], in which one end of the rod-shaped member 114 near the second connection terminal is open.

According to the connector fitting structure configured as described in [4], if the end of the rod-shaped member is not open and is connected to another member and the like, when foreign matter adheres to the rod-shaped member, the foreign matter is blocked and accumulated when the first connector and the second connector are fitted together, which may cause poor fitting. According to the configuration described above, since one end of the rod-shaped member near the second connection terminal is open, foreign matter is not accumulated, so that poor fitting can be further suppressed.

[5] The connector fitting structure according to any one of [1] to [4], in which
the first connector (the inlet plug 5) includes a guide groove (the fitting guide groove 85) provided in the first housing (the plug housing 80), and
the second connector (the inlet 1) includes a guide protrusion (the pick-up rib 19) that is inserted into the guide groove.

According to the connector fitting structure configured as described in [5], when the first connector and the second connector are fitted together, the guide groove is engaged with the guide protrusion, thereby making it possible to guide the first housing to be fitted into the second housing.

[6] The connector fitting structure according to [5], in which the connector cover 41 is provided so as to be rotatable between a closed position to cover an opening (the front opening of the hood part 21) to an accommodation space of the second connection terminal of the second housing and an open position not to cover the opening, and
the guide protrusion is provided on the connector cover, is accommodated in the second housing when the connector cover is in the closed position, is exposed outside the second housing when the connector cover is in the open position, and extends in the fitting direction of the first connector and the second connector.

According to the connector fitting structure configured as described in [6], the guide protrusion can be protected from dust and the like, thereby further suppressing poor fitting.

1. A connector fitting structure between a first connector and a second connector that are fitted and electrically connected to each other, wherein:
the first connector includes a first housing that accommodates a first connection terminal;
the second connector includes a second housing that accommodates a second connection terminal, and an abutment portion that is provided on a portion of the second housing and against which the first housing abuts before the first connector is fitted into the second connector;
the abutment portion includes a concave portion and a convex portion; and
a front end of the convex portion is configured to be an abutment surface.

2. The connector fitting structure according to claim 1, wherein a cross-sectional area of the front end of the convex portion is smaller than a cross-sectional area of a base end on the second housing side.

3. The connector fitting structure according to claim 1, wherein the abutment portion includes a rod-shaped member extending along a fitting direction between the first connector and the second connector.

4. The connector fitting structure according to claim 3, wherein one end of the rod-shaped member near the second connection terminal is open.

5. The connector fitting structure according to claim 1, wherein
the first connector includes a guide groove provided in the first housing, and
the second connector includes a guide protrusion that is inserted into the guide groove.

6. The connector fitting structure according to claim 5, wherein:
a connector cover is provided so as to be rotatable between a closed position to cover an opening to an accommodation space of the second connection terminal of the second housing and an open position not to cover the opening; and
the guide protrusion is provided on the connector cover, is accommodated in the second housing when the connector cover is in the closed position, is exposed outside the second housing when the connector cover is in the open position, and extends in the fitting direction of the first connector and the second connector.
